(19) United States
(12) Patent Application Publication
(10) Pub. No.: US 2008/0201275 A1
(43) Pub. Date: Aug. 21, 2008

(54) REAL ESTATE OCCUPANCY BOND

(76) Inventor: Michael C. Callahan, Carlisle, MA (US)

Correspondence Address: BROWN RUDNICK LLP, ONE FINANCIAL CENTER, BOSTON, MA, 02111, US

(21) Appl. No.: 12/021,765

(22) Filed: Jan. 29, 2008

Related U.S. Application Data
(60) Provisional application No. 60/898,030, filed on Jan. 29, 2007.

(51) Int. Cl. G06Q 90/00

(52) U.S. Cl. 705/500

(57) ABSTRACT

A method is provided for facilitating an alterable commitment to occupy real property. The first step includes providing a first party to occupy a real property asset to satisfy pre-determined alterable occupancy commitments. The second step includes providing a second party having at least one real property asset for satisfying the occupancy requirements of the first party. The third step includes forming an occupancy bond that includes a financial commitment between the first party and second party for a specified period of time.

### CROSS-REFERENCE TO RELATED APPLICATIONS

This patent application claims priority to Provisional Patent Application No. 60/898,030 filed Jan. 29, 2007, the entire contents of which are incorporated herein by reference.

### BACKGROUND

1. Technical Field

The present disclosure generally relates to the fields of commercial real estate, leasing and ownership of commercial real estate, and more particularly, to a business structure designed to create a new form of occupancy commitment for commercial real estate which enables the occupants of commercial property to have a more flexible occupancy commitment and be economically compensated for the value of that commitment.

2. Background of the Invention

Prior art commercial real estate occupancy is governed by one of two forms of occupancy commitment. The first, known as a lease, represents a contract between a tenant (“lessee”) and a property owner (“lessor”) that provides the lessee with a right to occupy specific real estate. The second, known as a direct property ownership, is an instance when a property to be occupied is owned by the occupying entity, or more specifically, the lessee and lessor are the same or related entities.

A lease is not commitment that is commercially valued in and of itself. Corporations, and other legal entities, traditionally lease space in buildings owned by third party landlords in order to restrict their economic occupancy commitment to the stipulated lease payments. Leases are typically executed for a specific property at a stated rent for a defined period of time.

Prior art leases suffer from several risks and drawbacks to the lessee and lessor. For example, the lessee obtains the ability to control a property and maintain a fixed cost during the term of the lease. The lessor is not provided with any flexibility inherent in the lease and may not change the lessee's occupancy requirements. The economic drawbacks of a lease include a fixed contract for specific space regardless of the lessee's need for the space and the lessee does not receive equity in the real property. Further, the lessee is not protected against future occupancy cost increases and does not receive a share in asset value appreciation.

Asset ownership involves a lessee making direct purchases of real estate assets that are intended for their own use. The benefits of ownership include indefinite control of the asset, occupancy costs not subject to third party landlord modifications, and equity rights in the asset that might provide economic gain. From a risk standpoint, the drawbacks of ownership include the lack of flexibility in the terms of occupancy and the occupancy and financial risks are 100% absorbed by the tenant. From an economic standpoint, to realize value from the property independent of borrowing, the property must be sold either vacant or leased. If the property is sold vacant, as much as 50% of the value is forgone when selling the empty building. To maximize the building's value, the lessee must execute a long-term lease, which contractually commits the lessee to long term rent payments, regardless of whether space is needed, and also has no inherent occupancy flexibility.

A need presently exists for a method to provide flexibility to the occupants of commercial real estate to establish pre-determined rights and abilities to make modifications to their existing occupancy commitment. Further, a need to be able to designate substitute facilities, without financial penalty, for the tenant's occupancy requirements should they change during the term of occupancy is necessary. Additionally, to the opportunity to satisfy this occupancy flexibility of commercial tenants, there further exists the opportunity to value this form of occupancy commitment and compensate the entity which makes this commitment for its economic value. Therefore the structure must not only define and provide the contractual rights to property occupancy and the ability to alter the terms of that occupancy, but to financially reward an entity for the value of its occupancy commitment.

### SUMMARY

Accordingly, a method for structuring a flexible, alterable occupancy commitment, that itself is discretely valued and financially compensated, is accomplished through the Occupancy Bond structure presented herein. The flexibility attributes of the Occupancy Bond provide occupancy that is both scalable and fungible. The ability to value the Occupancy Bond independent of the real estate to which it is applied enables entities to be economically compensated for the value their occupancy commitment contributes to the occupied real estate.

In a first aspect, a method for facilitating an alterable commitment to occupy real property is comprised of the steps including providing a first party occupying real property to satisfy pre-determined alterable occupancy commitments; providing a second party having at least one real property asset for satisfying the occupancy requirements of the first party; and forming an occupancy bond that includes a financial commitment between the first party and the second party for a specified period of time.

In one embodiment, the financial commitment between the first party to the second party is the first party pays specified monetary amounts for a specified period of time to the second party. The occupancy bond may include terms including the real property asset to be occupied, the size of the real property asset to be occupied, and the specified period of time of the first party's financial commitment to the second party. The second party may be obligated to accept amendments of the terms of the occupancy bond made by the first party after a fixed period of time. One of the amendments may also require the second party to provide a substitute real property asset to the first party if the first party chooses to move its physical occupancy from the real property asset to a substitute real property asset.

In another embodiment, the occupancy bond may have an economic value to the second party. The economic value may be equal to the monetary difference between the value of a occupied real property asset and an unoccupied real property asset. The first party may receive equity interests in at least one real property asset in exchange for the financial commitment. The equity interests may also include a discount in the size of the financial commitment, monetary distributions generated from the pool of real property assets, and ownership securities in at least one real property asset.

In a second aspect, a method for facilitating an alterable commitment to occupy real property includes the steps of providing a first party owning at least one real property asset; providing a second party forming a pool of real property assets not owned by the first party; and forming an occupancy bond that includes a financial commitment between the first party and the second party for a specified period of time.

In one embodiment, the first party contributes at least one real property asset to the second party in exchange for a financial commitment. The financial commitment between the first party and the second party may include the first party to a pay specified monetary amounts for a specified period of time to the second party.

In a second embodiment, the occupancy bond includes terms including the real property asset to be occupied, the size of the real property asset to be occupied, and a specified period of time of the first party's financial commitment to the second party. The second party may be obligated to accept amendments of the terms of the occupancy bond made by the first party after a fixed period of time. One of the amendments may also require the second party to provide a substitute real property asset to the first party if the first party chooses to move its physical occupancy from the real property asset to a substitute real property asset.

In a third embodiment, the occupancy bond has an economic value to the second party. The economic value may be equal to the monetary difference between the value of an occupied real property asset and an unoccupied real property asset. The first party may also receive equity interests in at least one real property asset or in the pool of real property assets not owned by the first party in exchange for a financial commitment.

In another embodiment, the equity interests may include a discount in the size of the financial commitment, monetary distributions generated from the pool of real property assets, and ownership securities in at least one real property asset or in the pool of real property assets not owned by the first party.

In a final aspect, an occupancy bond is comprised of a financial commitment between a first party and a second party for a specific real property asset and a pre-determined alterable occupancy requirement including the real property asset to be occupied, the size of the real property asset to be occupied, and a specified period of time of the first party's financial commitment to the second party. The first party may occupy a specific real property asset to satisfy the pre-determined alterable occupancy requirement and the second party may securitizes that financial commitment.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a flow chart detailing potential participants involved with an Occupancy Bond in accordance with the principles of the present disclosure; and

FIG. 2 is a flow chart detailing an example of relationships in a hypothetical business transaction utilizing an Occupancy Bond that is expanded from the flow chart presented in FIG. 1.

### DETAILED DESCRIPTION OF EXEMPLARY EMBODIMENTS

The exemplary embodiments of the Occupancy Bond's method of operation are disclosed and discussed in terms of occupancy commitments and their economic valuation for corporations. It is contemplated that this form of occupancy commitment can be utilized on behalf of other legal forms of real estate occupants, including municipal, state and federal governments, as well as institutions.

Corporations have two real estate occupancy options, owning or leasing. Neither option provides the flexibility necessary to meet companies' continually changing business demands nor delivers the valuation, liquidity and financial returns that are commensurate with other forms of corporate financial commitments.

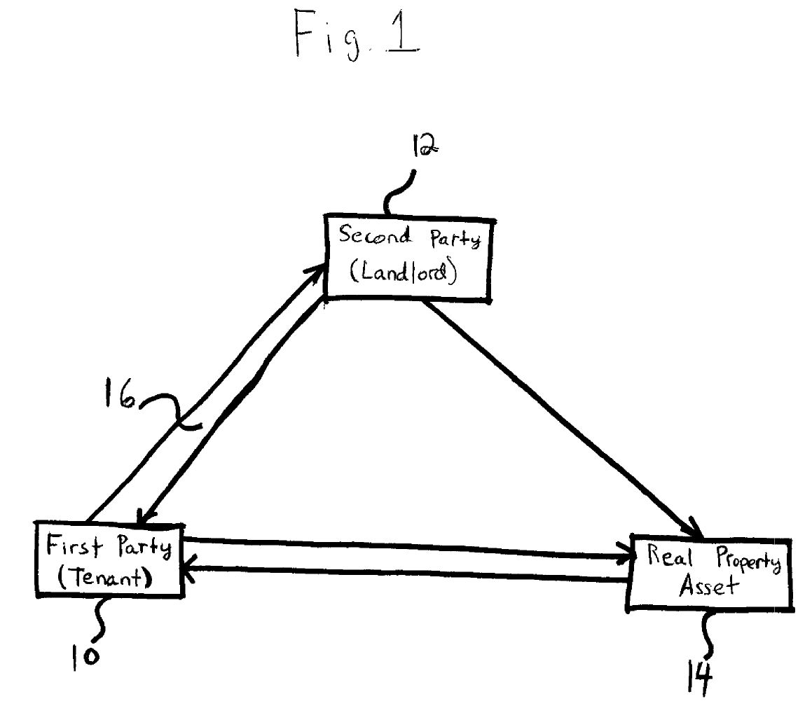

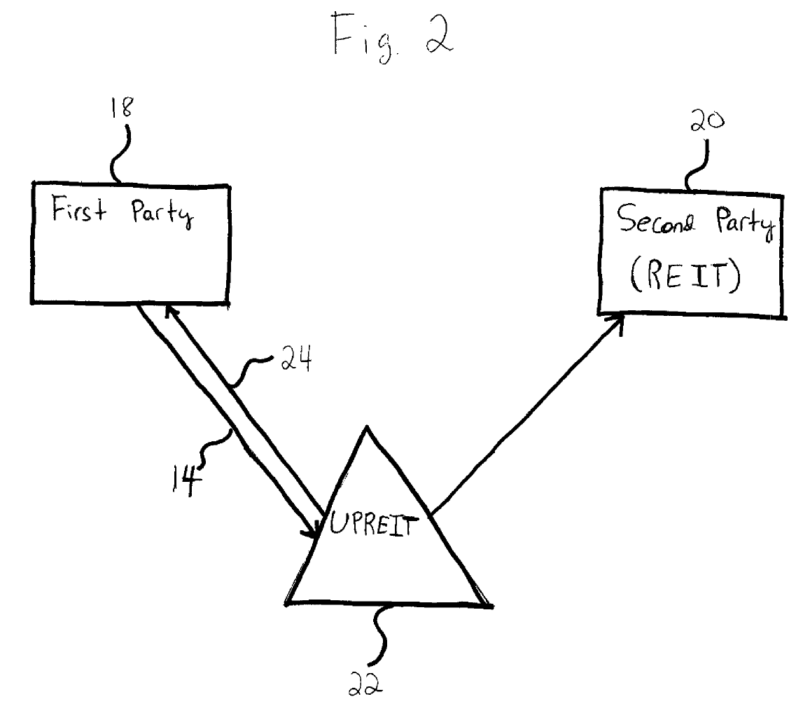

As explained in greater detail below with references to FIGS. 1-2, the Occupancy Bond is a method designed to create flexibility for corporate occupancy of real estate and to financially compensate the corporation for the value created by its occupancy commitment. The Occupancy Bond is a new method of facilitating corporate occupancy and may be utilized in connection with an owner of real estate that is able to provide the commitments that the Occupancy Bond requires of a property owner.

The Occupancy Bond is intended to be utilized by a property owner that owns a portfolio of real estate assets. A portfolio of appropriate size allows the owner to diversify the risk associated with a single asset and to make possible additional asset acquisitions to satisfy the needs of Occupancy Bond contributors, as well as to improve the financial performance of the real estate portfolio.

The Occupancy Bond bifurcates a company's occupancy commitments from the related occupied real estate assets, and therefore, enables independent valuation and transaction of these two components of corporate real estate. Under the Occupancy Bond, a company commits to pay a stated minimum annual dollar amount of rent over a stated (i.e., ten year) period, but that commitment is not tied to any specific property.

The Occupancy Bond allows corporations to modify property occupancy terms (scalability) and substitute facilities (fungibility) as their business changes without financial penalties. When combined with an investment real estate operation or fund, the Occupancy Bond can convert corporate fixed assets and lease obligations into liquid investments in a diversified real estate pool priced at fair market value. Furthermore, this process provides participating companies with a unique occupancy flexibility that transfers real estate risk away from the company, and significantly reduces operating and capital costs.

Referring to FIG. 1, a first party 10 may form an Occupancy Bond 16 with a second party 12 in exchange for the right to occupy a real property asset 14. It is contemplated that the first party 10 may be a tenant and the second party 12 may be a landlord as typically defined in a landlord-tenant relationship. In a one embodiment, the first party 10 is a commercial tenant of real property, and the second party 12 is a property owner of at least one commercial real property asset 14.

In a preferred embodiment, it is assumed that the first party 10 is a corporation. It is further preferred that the second party 12 is a property owner that is a sufficiently capitalized real estate operating business such as an investment fund that has the ability to transact properties of sufficient size and quantity to satisfy all Occupancy Bond 16 commitments. Moreover, in a preferred embodiment, the real property asset 14 are commercial properties and may be part of a portfolio of real property assets acquired to satisfy explicit and projected needs of the first party 10. The real property asset 14 may be acquired either through a contribution by the first party 10 themselves, or by an acquisition from the commercial real estate market at large.

The intent of FIG. 1 is to show the primary relationships operative in the Occupancy Bond 16. In one embodiment, the first party 10 makes an Occupancy Bond commitment 16 and pays rent to the second party 12. In return, the first party 10 receives two fundamental benefits. First, the second party 12 may provide the real property asset 14 that the first party 10 will occupy (including various occupancy flexibility rights) for its business purposes. Second, the first party 10 may receive economic benefits from the second party 12 based upon the added economic value of the first party's 10 Occupancy Bond 16 commitment. These benefits may take a variety of forms including equity ownership in the real property asset 14 or occupancy based incentives such as a rent reduction.

The Occupancy Bond 16 may be a form of a financial commitment that commits the first party 10 to pay stipulated monetary amounts of rent for a specified period of time and grants the first party 10 flexibility rights and economic benefits. By comparison, a lease is a contract by a tenant to rent a specific building at a specific price for a specific term that is an asset based commitment and not a monetary based commitment. The lease does not intrinsically account for and compensate the tenant for the economic value provided by the lease.

While FIG. 1 shows the core relationships that exist for an Occupancy Bond 16 to function, FIG. 2 depicts one potential business structure in order to describe how Occupancy Bond requirements for a group of corporations may be satisfied within an existing commercial real estate business model.

Referring to FIG. 2, a first party 18 may be corporate tenants and participants in the model for executing Occupancy Bond 24 and occupy commercial space. In one embodiment, the first party 18 is a corporation or group of corporations. The first party 18 will pay rent under their Occupancy Bond 24 and receive appropriate occupancy rights pursuant to those payments. The first party 18 will have an ability to make property contributions into the real estate pool and will receive an economic interest in that pool based upon the value of the assets they contribute plus the value of the Occupancy Bond 24 commitment made. In another embodiment, the first party 18 makes additional real property contributions or Occupancy Bond commitments to an Umbrella Partnership Real Estate Investment Trust 22 (“UPREIT”), and therefore, the first party 10 will correspondingly receive additional UPREIT 22 equity interests.

The UPREIT 22 may be a Limited Liability Corporation (“LLC”) or an Operating Partnership (“OP”). An UPREIT 22 may be an OP employed in real estate transactions to enable the first party 18 to contribute and monetize real estate assets 14 in a tax deferred manner. A typical OP may have limited partners and a general partner. The limited partners are the first party 18 and the General Partner is the second party 20. In a preferred embodiment, the second party 20 is a Real Estate Investment Trust (“REIT”).

In an embodiment, the general partner of the OP is a REIT, which serves as an efficient investment vehicle to raise equity from the capital markets that is in turn contributed into the UPREIT 22 to help fund real estate acquisitions and other operations of the UPREIT 22. In return for supplying capital to the UPREIT 22, the REIT 20, as general partner, may receive equity ownership and distributions from the UPREIT 22, which are allocated to its investors.

The UPREIT 22 may procure debt for its operations from lenders in the marketplace. The UPREIT 22 may also lease vacant space it owns and receive rent from other Corporate Real Estate (CRE) tenants in the marketplace apart from the first party 18 involved in the UPREIT 22 structure and Occupancy Bond 24.

In addition to property transacted directly with participating first party 18, the UPREIT 22 may acquire and sell properties in the open CRE marketplace to meet the needs of its occupancy and investment requirements. These property transactions may either provide or require net capital proceeds for the UPREIT 22.

The UPREIT 22 business model presented is just one example of how an Occupancy Bond 24 structure can be integrated within an existing real estate operating form. In a preferred embodiment, the first party 18 makes real estate asset 14 and Occupancy Bond 24 commitments to the UPREIT 22 that is in turn responsible for providing the required space to be occupied within a financial and investment structure.

TABLE 1
General Assumptions
Building type Prototype B - Suburban Office/flex
Occupancy Single Tenant
Escalations Tenant pays increases in real estate taxes/expenses
Absorption Time (months) 12
Vacancy & Collection Loss 4%
Building Area (Sq. Ft.) 346,027
Market Rent per Sq. Ft. (Modified Gross) $27.00
Contract Rent Increase 3.0%
Downtime Between Leases (months) 12
Renewal Probability 65%

| Scenario | Dark | 5-Year Lease | 10-Year Lease | 15-Year Lease | 20-Year Lease |
|---|---|---|---|---|---|
| Leasing Assumptions | | | | | |
| Lease Term (Years) | | | | | |
| Initial Lease | 7 | 5 | 10 | 15 | 20 |
| Future Leases | 7 | 7 | 7 | 7 | 7 |
| Tenant Improvements | | | | | |
| New Leases | $22.50 | $22.50 | $22.50 | $22.50 | $22.50 |
| Renewal Leases | $5.00 | 15.00 | $5.00 | $5.00 | $5.00 |
| Leasing Commissions | | | | | |
| Original Lease | 33.0% | — | — | — | — |
| New 7-year leases | 33.0% | 33.0% | 33.0% | 33.0% | 33.0% |
| Renewal 7-year leases | 16.5% | 16.5% | 16.5% | 16.5% | 16.5% |
| DCF Modeling Assumptions | | | | | |
| Holding Period | 10 | 10 | 11 | 10/16 | 10/21 |
| Projection Period | 11 | 11 | 12 | 11/17 | 11/22 |
| Growth Rates | | | | | |
| Market Rent | 3.00% | 3.00% | 3.00% | 3.00% | 3.00% |
| Expenses | 3.00% | 3.00% | 3.00% | 3.00% | 3.00% |
| Real Estate Taxes | 3.00% | 3.00% | 3.00% | 3.00% | 3.00% |
| Rates of Return (Based on current environment) | | | | | |
| Original Going-in Rate | 8.00% | 8.00% | 7.75% | 7.50% | 7.25% |
| Discount Rate | 9.50% | 9.00% | 9.00% | 8.50% | 8.50% |
| Terminal Cap Rate | 8.00% | 8.00% | 8.00% | 8.50% | 8.50% |
| Reversionary Sales Cost | 3.00% | 3.00% | 3.00% | 3.00% | 3.00% |
| Indicated Values | $51,663,000 | $72,870,000 | $76,083,000 | $84,570,000 | $90,956,000 |
| Holding Period 1 | | | | | |
| Value Delta | — | 41.05% | 47.27% | 63.70% | 76.06% |
| Holding Period 1 | | | | | |
| COB Value | $0 | $21,207,000 | $24,420,000 | $32,907,000 | $39,293,000 |

In Table 1 above, a sample Occupancy Bond 24 valuation is provided. The purpose of the table is not to develop or defend a specific methodology for calculating the value of the Occupancy Bond 24, but rather to demonstrate conceptually how an Occupancy Bond 24 may be valued. The valuation is analyzing a specific property example and looking at how the value of the real property asset 14 changes as the lease term changes. The Occupancy Bond 24 value is effectively the additive value that a lease creates to the value of a vacant real property asset 14.

At the top of the table, the general assumptions are the real property asset 14, the type of property, and the real estate market. Below, the assumptions in the body of the table plot different real estate business variables in the left column versus the length of lease (occupancy) term across the top row. The resultant Occupancy Bond 24 valuation across the bottom row calculates the value attributable to the corresponding occupancy term of each Occupancy Bond 24 scenario.

The results show that a “Dark” real property asset 14 (one that is vacant and has no lease/occupancy) would produce a zero Occupancy Bond 24 value. The other values in this analysis calculate the total value of the real property asset 14 with a given lease/occupancy term, then subtract the Dark value from that result with the difference being the economic value of the Occupancy Bond 24.

The Dark value of the real property asset 14 is projected to be $51,663,000. The value of the real property asset 14 with a 5 year lease is projected to be $72,870,000. The value of the Occupancy Bond 24 for the 5 year lease would be the difference between these two values, or $21,207,000. By extension, the value of the Occupancy Bond 24 for a 10 year lease is equal to the difference between the real property asset 14 value with a 10 year lease, $76,083,000, and the Dark value, $51,663,000, or $24,420,000. This same analysis continues for lease terms of 15 and 20 years.

In summation, Table 1 provides an example of how an Occupancy Bond 24 may be valued as the difference between a real property asset's 14 value empty (unleased) versus the value of the same real property asset 14 with a lease commitment. The table shows that the longer the lease term, the greater the Occupancy Bond 24 value will be. For purposes of this discussion, the terms “lease” and “occupancy” have been used interchangeably. The value an Occupancy Bond 24 provides to the REIT 20 is similar (though not identical) to the value a lease provides to a single asset. In each case, the occupancy commitment by a first party 18 creates additive investment value to the Dark value of the individual asset or portfolio, respectively.

Prior to examining Table 2, it is helpful to detail the operative rules governing an Occupancy Bond 24 in a prospective Occupancy Bond UPREIT 22 based transaction. In one embodiment, the Occupancy Bond 24 will have a ten year term that is a monetary denominated commitment. The Occupancy Bond 24 may be established for specific real property asset 14 at the outset and that the Occupancy Bond 24 may be transferred to substitute premises during the term of the Occupancy Bond 24. If a substitution occurs, the Occupancy Bond 24 may be extended to a new ten year term starting at the time of property substitution and that space occupied may be increased or decreased by an agreed upon amount (i.e., plus or minus 25%). This change may result in a directly proportionate change to the annual Occupancy Bond 24 payment and a reciprocal change to the remaining term of the Occupancy Bond 24.

The first party 18 may receive equity in the real estate entity 14 for the value of the Occupancy Bond 24 and any real property asset 14 or Occupancy Bond 24 contributions made by first party 18 to the UPREIT 22 may be tax deferred contributions. Moreover, the UPREIT 22 may arrange tax deferred debt transactions in order to distribute 50%-85% of the asset value in cash to the first party 18. Furthermore, any excess cash flow generated by the REIT 20 may be distributed to the first party 18 with ownership interests in the REIT 20 and the interests the first party 18 may receive will either be marketable securities in the REIT 20 or interests that are convertible to marketable securities. The securities held by the first party 18 may also be pledged to secure additional borrowing for first party 18 on an individual basis and that a conversion of corporate fixed assets into securities effectively takes place.

TABLE 2

| | Leased | Unencumbered | | |
|---|---|---|---|---|
| | Facilities | Owned Asset | Sale Leaseback | UPREIT 22 |
| Equity Retained | No | Yes | No | Yes |
| Equity valued at | N/A | No | N/A | Yes |
| FMV | | | | |
| Taxable event | No | No | Yes | No |
| FMV monetization | N/A | N/A | 100% | 50%-85% |
| Typical | 10 years | 2-3 years | 15-20 years | 10 years |
| commitment term | | | | |
| Occupancy | Fair-poor | Fair-poor | Poor | Strong |
| flexibility | | | | |
| Quality of RE | None | Fair | None | Strong |
| investment value | | | | |
| Diversification of | Fair | Fair | Poor | Strong |
| operating risk | | | | |
| Cash flow yield | No | No | No | Yes |
| Leverage ability | No | Fixed through | Maximum fixed | Variable through |
| | | new transaction | leverage | public securities |

Table 2 is a comparison of alternative transactions comparing the Occupancy Bond UPREIT 22 outlined in FIG. 2 with traditional transaction options available to first party 18. The purpose of the table is to show the beneficial results an UPREIT 22 structure can provide if an Occupancy Bond 24 occupancy structure is employed.

Each row in the table represents one of the transaction forms to be compared. Leased facilities are buildings leased by a company. Unencumbered Owned Assets are buildings owned by the company that have no debt or other financial obligations. A Sale Leaseback is a transaction where a company sells an asset it owns and leases it back as part of the transaction. The UPREIT 22 is the transaction form depicted in FIG. 2 which employs the use of the Occupancy Bond 24 within a conventional UPREIT 22 real estate investment structure.

The results of Table 2 show the occupancy flexibility and financial benefits of the Occupancy Bond 24 occupancy structure compared with the traditional occupancy options. In one embodiment, the Occupancy Bond UPREIT 22 retains equity in the real estate assets for the corporation which Leased Facilities and a Sale Leaseback do not. The Occupancy Bond UPREIT 22 may be the only solution which values equity interests at fair market value. The contribution of assets into the UPREIT 22 may not be a taxable event whereas a Sale Leaseback is a taxable transaction. While the Sale Leaseback monetizes 100% of the asset value in a taxable transaction, the Occupancy Bond UPREIT 22 may monetize up to 85% of the value and may be a tax deferred transaction that retains equity for the corporation.

In another embodiment, the Occupancy Bond UPREIT 22 requires a 10 year commitment term, similar to a lease, but significantly shorter than a traditional Sale Leaseback. The Occupancy Bond UPREIT 22 is the only alternative that has strong occupancy flexibility characteristics because of the Occupancy Bond 24 allowances, whereas as all other transaction alternatives have fixed occupancy commitments that result in fair or poor occupancy flexibility.

The Occupancy Bond UPREIT 22 provides that the debt leverage is variable i.e., up to the control of the corporation. Compared with the other transaction alternatives, the Occupancy Bond UPREIT 22 is the only alternative that produces superior occupancy flexibility, diversification of operating risk and quality of investment value. The Occupancy Bond 24 typically carries a 10 year term and is the only alternative that produces a cash flow yield.

In a preferred embodiment, the Occupancy Bond 24 contractually defines the rights and responsibilities of first party 18, the second party 20, and the UPREIT 22, and therefore, produces several benefits. First, the corporate occupancy may be fungible through no-cost transferal to substituted premises. Second, there may be cost free modifications to the size of the real property asset 14 within predetermined limits (scalability). Third, the real property asset 14 lease rates may reflect Fair Market Value (“FMV”) pricing of the individual assets and corporate credits. Fourth, management may be enabled to optimize real property asset 14 commitments despite changing business conditions. Fifth, the risk of changing occupancy requirements from the first party 18 to the UPREIT 22 may be transferred.

In another embodiment, the Occupancy Bond UPREIT 22 significantly improves Corporate Real Estate financial performance. The Occupancy Bond 24 occupancy flexibility may convert fixed operating/capital costs to scalable expenses. Efficient CRE utilization may translate into fewer owned and leased facilities. Unlike a lease, the Occupancy Bond 24 may explicitly calculate, and grants equity interests to the first party 18 for the economic value created by the Occupancy Bond 24, thereby eliminating substantial wealth transfer to third party landlords. Additionally, the first party 18 may receive maximum investment value for owned assets without the restrictions of a long-term building lease.

Corporate contributed real property assets 14 may be valued as vacant investment properties of the REIT 20. Moreover, an efficient ownership structure may capitalize the tax deferred FMV of contributed assets within a publicly traded diversified asset/corporate credit portfolio. Furthermore, modest Occupancy Bond 24 annual rent may increase augment portfolio income stream. The corporate Real Estate solution may also minimize operating expenses while maximizing CRE investment value.

With owning or leasing, corporations are forced to absorb medium to long-term space surpluses and deficits. Contracted/owned commitments cannot adjust to the frequently changing needs of corporations resulting in a supply/demand disequilibrium. Major corporate leases typically have a minimum 10 year term with no termination rights. Owned assets sell at discounts of up to 40% if vacant, or require a 15-20 year leaseback to maximize asset value for single tenant buildings.

The Occupancy Bond 24 may be a monetary denominated commitment between the first party 18 and the UPREIT 22. All occupancy structuring may be performed on the fungible basis of “lease dollars,” and is not constrained by the square feet occupied in a real property asset 14. To accommodate occupancy changes, the annual rent commitment can increase/decrease by 25% without penalty to the first party 18 (with a reciprocal change in the Occupancy Bond 24 term length). No monetary penalty is incurred when a first party 18 vacates a real property asset 14 during the term of the Occupancy Bond 24.

Per the terms of the Occupancy Bond 24, the first party 18 may lease space in another real property asset 14 owned by the UPREIT 22 and extend the associated Occupancy Bond 24 to a new 10 year term. A substitute facility may be acquired by the REIT 22 or contributed by the first party 18. The first party 18 receives UPREIT 22 equity interests equal to the aggregate value of all contributed properties plus Occupancy Bond 24 commitments.

It will be understood that various modifications may be made to the embodiments disclosed herein. Therefore, the above description should not be construed as limiting, but merely as exemplifications of the various embodiments of the invention. Those skilled in the art will envision other modifications within the scope and spirit of the claims appended hereto.

What is claimed is:

1. A method for facilitating an alterable commitment to occupy real property, comprising the steps of:
providing a first party occupying real property to satisfy pre-determined alterable occupancy commitments;
providing a second party having at least one real property asset for satisfying the occupancy requirements of the first party; and
forming an occupancy bond, wherein the occupancy bond includes a financial commitment between the first party and the second party for a specified period of time.

2. A method of claim 1, wherein the financial commitment between the first party to the second party is the first party pays specified monetary amounts for the specified period of time to the second party.

3. A method of claim 1, wherein the occupancy bond includes terms including the real property asset to be occupied, a size of the real property asset to be occupied, and the specified period of time of the first party's financial commitment to the second party.

4. A method of claim 3, wherein the second party is obligated to accept amendments of the terms of the occupancy bond made by the first party after a fixed period of time.

5. A method of claim 4, wherein one of the amendments requires the second party to provide a substitute real property asset to the first party if the first party chooses to move its physical occupancy from the real property asset to the substitute real property asset.

6. A method of claim 1, wherein the occupancy bond has an economic value to the second party.

7. A method of claim 6, wherein the economic value is equal to the monetary difference between the value of the occupied real property asset and an unoccupied real property asset.

8. A method of claim 7, wherein the first party receives equity interests in the at least one real property asset in exchange for the financial commitment.

9. A method of claim 8, wherein the equity interests include a discount in the size of the financial commitment, monetary distributions generated from the pool of real property assets, and ownership securities in the at least one real property asset.

10. A method for facilitating an alterable commitment to occupy real property, comprising the steps of:
providing a first party owning at least one real property asset;
providing a second party forming a pool of real property assets not owned by the first party; and
forming an occupancy bond, wherein the occupancy bond includes a financial commitment between the first party and the second party for a specified period of time.

11. A method of claim 10, wherein the first party contributes at least one real property asset to the second party in exchange for the financial commitment.

12. A method of claim 10, wherein the financial commitment between the first party and the second party includes the first party to a pay specified monetary amounts for the specified period of time to the second party.

13. A method of claim 10, wherein the occupancy bond includes terms including the real property asset to be occupied, a size of the real property asset to be occupied, and the specified period of time of the first party's financial commitment to the second party.

14. A method of claim 13, wherein the second party is obligated to accept amendments of the terms of the occupancy bond made by the first party after a fixed period of time.

15. A method of claim 14, wherein one of the amendments requires the second party to provide a substitute real property asset to the first party if the first party chooses to move its physical occupancy from the real property asset to the substitute real property asset.

16. A method of claim 10, wherein the occupancy bond has an economic value to the second party.

17. A method of claim 16, wherein the economic value is equal to the monetary difference between the value of the occupied real property asset and an unoccupied real property asset.

18. A method of claim 10, wherein the first party receives equity interests in the at least one real property asset or in the pool of real property assets not owned by the first party in exchange for the financial commitment.

19. A method of claim 18, wherein the equity interests include a discount in the size of the financial commitment, monetary distributions generated from the pool of real property assets, and ownership securities in the at least one real property asset or in the pool of real property assets not owned by the first party.

20. An occupancy bond comprising:
a financial commitment between a first party and a second party for a specific real property asset;
a pre-determined alterable occupancy requirement including the real property asset to be occupied, a size of the real property asset to be occupied, and a specified period of time of the first party's financial commitment to the second party;
wherein the first party occupies the specific real property asset to satisfy the pre-determined alterable occupancy requirement and the second party securitizes the financial commitment.
